(19) United States
(12) Patent Application Publication
(10) Pub. No.: US 2002/0061421 A1
(43) Pub. Date: May 23, 2002

(54) Spin valve device with spin-dependent, specular electronic reflection

(75) Inventor: Bernard Dieny, Lans En Vercors (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: COMMISSARIAT A L'ENERGIE ATOMIQUE, PARIS (FR)

(21) Appl. No.: 09/961,255

(22) Filed: Sep. 25, 2001

(30) Foreign Application Priority Data
Sep. 26, 2000 (FR) 00 12203

(51) Int. Cl. G11B 5/39

(52) U.S. Cl. 428/692

(57) ABSTRACT

Spin valve device with spin-dependent, specular electronic reflection.

The device comprises an electrically conductive, nonmagnetic layer placed between two magnetic layers. According to the invention, at least one of these magnetic layers (R, R′, F) has a specular electronic reflection dependent on the orientation of the spin of the electrons relative to the magnetization direction.

Application to the implementation of magnetic field sensors, read heads, memories, etc.

### TECHNICAL FIELD

The present invention relates to a spin valve device with spin-dependent, specular electronic reflection. It has applications in the implementation of magnetic field sensors (for robotics or the car industry in exemplified manner), the implementation of read heads for magnetic recording supports, magnetic memories, etc.

### PRIOR ART

A spin valve is constituted by a stack of thin layers or films with at least two ferromagnetic layers separated by an intermediate, nonmagnetic and electrically conductive layer.

The resistance of such a stack is a function of the magnetic field applied. The passage of a current in the intermediate layer makes it possible to measure said resistance and in this way access the field.

U.S. Pat. No. 4,949,039 granted on Aug. 14, 1990 to P. GRUNBERG describes such a device. Its structure is illustrated in the attached FIG. 1, where it is possible to see a stack comprising a first ferromagnetic layer 1, a second ferromagnetic layer 2 and an intermediate, nonmagnetic and electrically conductive layer 3. The materials constituting the ferromagnetic layers 1 and 2 can be iron, cobalt, nickel or alloys of these materials with in particular Cu, Cr, Si, Mo, Zr, Zn, V, Al, Mn, B, Tb. The intermediate layer can be of copper, gold, silver, etc.

The first magnetic layer 1 has a magnetization M1 e.g. directed longitudinally, i.e. in the direction of the greatest dimension of the ribbon constituting the stack. The same applies for the magnetization M2 of the second magnetic layer 2. These two magnetizations can be antiparallel, as shown in the drawing, i.e. their directions are opposed, but they can also be parallel. It is the change in the relative orientation of the magnetizations of these two layers which is accompanied by a variation in the electrical resistance of the structure.

The thickness of the intermediate layer 3 must be sufficiently great to prevent a direct coupling between the magnetic layers 1 and 2, but sufficiently small so that it is less than the free, average path of the conduction electrons. Generally a thickness of approximately 2 to 5 nm is suitable.

The physical phenomenon on which said device is based is linked with the diffusion of conduction electrons in the magnetic layers or at the interfaces between these layers and the intermediate layer, said diffusion having a level dependent on the orientation of the spin of these electrons compared with the magnetization of the neighbouring area. If the two magnetizations are parallel, one category of electrons (e.g. magnetization-parallel, spin electrons) is weakly diffused in the two magnetic layers. Therefore said electrons can transport a large amount of current, which leads to a high electrical conductivity state.

However, if the two magnetizations are antiparallel, the two electron categories (i.e. with spin parallel and antiparallel to the local magnetization) are highly diffused in one or other of the magnetic layers. The electrical conductivity is consequently reduced compared with the situation of a parallel alignment of the magnetizations. This phenomenon is known as giant magnetoresistance.

Thus, the resistance is higher with antiparallel than with parallel magnetizations.

In order to control the relative orientation of the magnetizations, the magnetization of one of the magnetic layers is conventionally pinned by exchange coupling with an anti-ferromagnetic layer (e.g. PtMn or PdPtMn). The layer whose magnetization is fixed is normally called the pinned layer. The anti-ferromagnetic layer introduced for pinning the magnetization of the adjacent ferromagnetic layer is called the pinning layer.

The magnetization of the other magnetic layer constituted by a magnetically soft material (e.g. Ni₈₀Fe₂₀) is free to follow the variations of the magnetic field applied to the system. This layer is known as the free layer. The application of a magnetic field consequently leads to a modification of the relative orientation of the magnetizations of the two magnetic layers, which is accompanied by a variation of the electrical resistance of the stack. To measure said resistance variation, it is merely necessary to provide two conductors 4 and 5 connected to a current source 6 and to circulate a current I in the stack (in practice in the intermediate layer 3). An apparatus 7 measures the voltage at the terminals of the stack. For a constant current, the voltage variation reflects the resistance variation, i.e. the value of the field applied.

Numerous improvements have been made to these structures since they were invented in 1990, i.e. the use of synthetic pinned layers, introduction into soft, pinned layers of thin oxide layers increasing the specular reflection of the electrons at the interfaces, replacement of part of the magnetic layer by a high conductivity, nonmagnetic layer (spin filter-spin valve).

The resistance values obtained at present are approximately 8 to 15% at ambient temperature, the absolute sheet resistance change between the parallel and antiparallel configurations being approximately 2 to 2.50 Ω. These structures are suitable for an information storage density of 50 Gbits/inch², i.e. approximately 8 Gbit/cm².

However, the constant rise in the information capacity stored on hard disks (increase of more than 60% annually) makes it necessary to further increase the sensitivity of the magnetoresistive element used for the rereading of stored information. It is consequently necessary to find means for further increasing the amplitude of the magnetoresistance of these spin valves.

### DESCRIPTION OF THE INVENTION

To this end, the invention proposes a spin valve based on magnetic layers having specular reflection coefficients of the electrons dependent on the direction of the spin of said electrons relative to the magnetization of the magnetic layers. This property is different from that used in the prior art, where it is the diffusion occurring at the interfaces (or in the volume of the magnetic layers), which is dependent on the spin direction.

More specifically, the present invention relates to a spin valve device comprising at least one stack of layers comprising an electrically conductive, nonmagnetic layer placed between a first and a second magnetic layers, the first and second magnetic layers having a magnetization with a certain direction, said device being characterized in that at least one of said first and second magnetic layers has, at the interface with the nonmagnetic layer, a specular reflection for the conduction electrons dependent on the orientation of the spin of the electrons relative to the magnetization direction in the magnetic layer or layers.

Three variants are proposed:

1) Variant 1: The structure comprises a stack in the form R/NM/R′, where R and R′ designate two magnetic layers having a specular reflection of the electrons dependent on the spin (e.g. Fe₃O₄), NM designates a nonmagnetic layer which is a good conductor of electric current (e.g. copper). The thickness of the layer NM is less than a few times the free path of the electrons in said layer (typically less than 10 nm).

2) Variant 2: The structure comprises a stack in the form R/NM/F, where R and NM have the same meaning as hereinbefore and F designates a ferromagnetic layer permitting a diffusion dependent on the spin of the electrons, occurring at the interface NM/F or in the volume of the layer F. Layer F can e.g. be a layer of a transition metal or alloys of transition metals such as permalloy (Ni₈₀Fe₂₀) or the alloy Co₉₀Fe₁₀. As previously, the thickness of the layer NM is less than a few times the free average path in said layer (typically less than 10 nm), whilst that of the layer F is less than the free average path of the least diffused electrons in said layer (spin electrons parallel to the magnetization in permalloy, typically 10 nm).

3) Variant 3: The structure comprises a stack in the form R/NM/F/NM′/R′. The layers R and R′ have the same meanings as hereinbefore, NM and NM′ are two nonmagnetic layers, which are good conductors of electric current, the layer F representing a ferromagnetic layer or a stack of ferromagnetic layers having the diffusion dependent on the spin at the interfaces with the layers NM and NM′ or in the volume of F.

These three stack types can be combined with other magnetic or nonmagnetic layers located on either side of the stacks and intended to permit a better control of the relative orientation of the magnetizations by the application of a magnetic field.

### BRIEF DESCRIPTION OF THE DRAWINGS

FIG. 1, already described, shows a known spin valve device.

FIG. 2 diagrammatically illustrates in section a device according to the first variant of the invention.

FIG. 3 illustrates an embodiment of the first variant.

FIGS. 4A, 4B and 4C show the variations of certain magnitudes (sheet resistance, absolute magnetoresistance, relative magnetoresistance), inherent in the first variant as a function of the thickness of the separating, nonmagnetic layer.

FIGS. 5A, 5B and 5C show the variations of said same magnitudes as a function of the specular reflection coefficient of the electrons at the magnetic layer/nonmagnetic layer interface.

FIGS. 6A, 6B, 6C and 6D show the variations of certain magnitudes (sheet resistance, absolute magnetoresistance, relative magnetoresistance and sheet conductance) for different specular reflection contrasts as a function of the thickness of the separating, nonmagnetic layer.

FIG. 7 diagrammatically and in section illustrates a device according to the second variant of the invention.

FIG. 8 illustrates a special embodiment of said second variant.

FIGS. 9A, 9B and 9C show the variations of the sheet resistance, absolute magnetoresistance and relative magnetoresistance as a function of the thickness of the nonmagnetic layer for the second variant of the invention.

FIGS. 10A, 10B and 10C show the variations of said same magnitudes as a variation of the thickness of the separating, nonmagnetic layer.

FIG. 11 diagrammatically illustrates in section a device according to the third variant of the invention.

FIGS. 12A and 12B show the variations of the relative and absolute magnetoresistance of a device according to the third variant, as a function of the thickness of the ferromagnetic layer.

### DETAILED DESCRIPTION OF EMBODIMENTS

The invention can be implemented in several ways. As non-limitative examples, a description will be given of three apparently advantageous variants.

1. First variant: structure of the type R/NM/R′

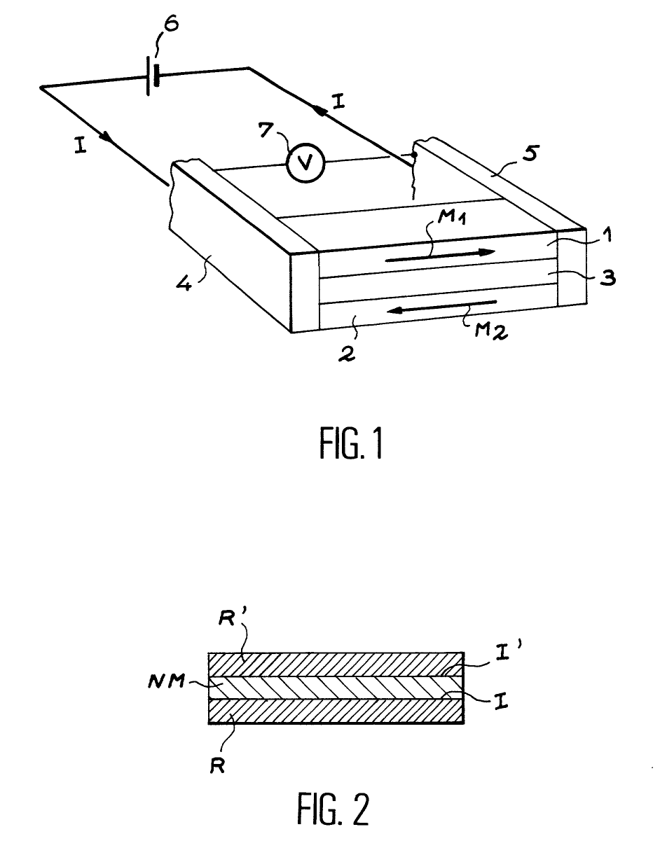

This first variant is illustrated in FIG. 2, where it is possible to see a stack comprising a layer NM placed between a layer R and a layer R′. The R/NM and R′/NM interfaces are designated I and I′.

The references R and R′ represent magnetic layers having spin-dependent, specular electronic reflection effects. Numerous oxides can have such an effect, namely magnetic oxide layers such as Fe₃O₄, other ferrimagnetic oxides based on nickel, cobalt or iron having a spinel structure, magnetic garnets, CrO₂, etc. Ferromagnetic nitride layers based on iron and/or nickel and/or cobalt can also have such effects.

The layer NM is an electricity conducting, nonmagnetic layer, e.g. of metal such as copper, gold, silver and any metal having a sufficiently low resistivity (typically below 20 Ω.cm).

All these layers can be deposited on an insulating or semiconductor substrate in order to prevent a derivation of the current to the outside of the active part of the structure, i.e. layer NM and immediately adjacent layers. The deposition method can be cathodic sputtering from a target of the compound to be deposited or reactive sputtering. Other deposition methods such as molecular jet epitaxy, laser ablation or chemical vapour deposition (CVD) can also be used.

The thicknesses of the layers R and R′ are between an atomic plane and a few hundred nm. In view of the fact that these materials are insulating or very highly resistive, they derive little current and consequently they can have a relatively significant thickness. This thickness must be determined by the possibility of controlling the relative orientation of the magnetizations of these two layers R and R′. To ensure this control, it is possible to couple one of the layers R or R′, e.g. R, with a layer of an anti-ferromagnetic material permitting the pinning of the magnetization of said layer (e.g. pinning a Fe₃O₄ layer by depositing an adjacent Fe₂O₃ layer). Moreover, in order to be able to easily reverse the magnetization of the opposite layer, R′ in this example, the thickness of R′ can be made sufficiently small (approximately 1 nm) and it can be coupled to a magnetically soft layer such as of Ni₈₀Fe₂₀ with a sufficiently small thickness (typically 1 to 3 nm) so as not to derive an excessive current quantity. The thin oxide layer coupled to the soft layer and having a spin-dependent reflection can also be formed by firstly depositing the soft metallic layer and then surface-oxidizing the same by introducing oxygen into the preparation chamber or air or by using an oxygen plasma or a dissociated oxygen gun or by any other oxidation procedure used for the manufacture of oxide barriers in magnetic tunnel junctions. The latter are known to the expert.

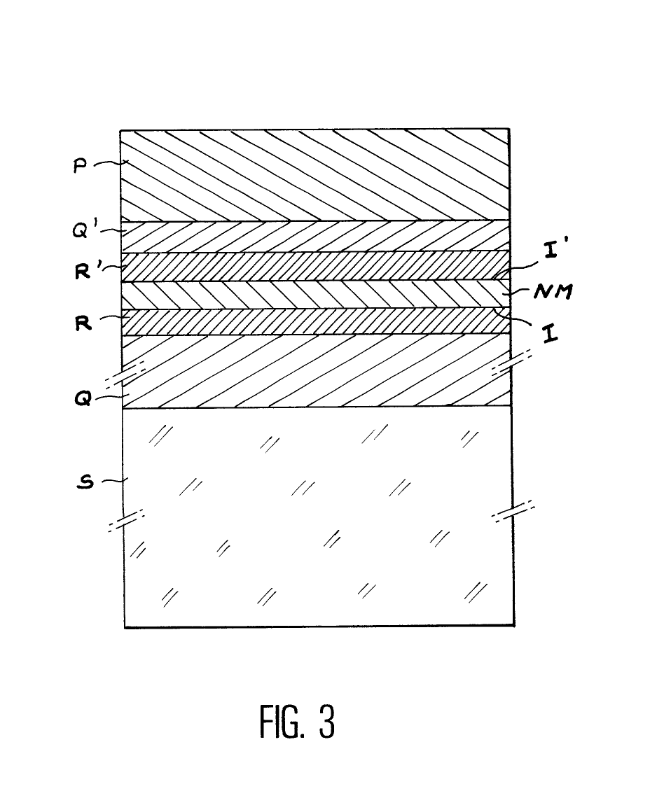

FIG. 3 illustrates an embodiment of this first variant. The device comprises a substrate S, a layer Q, e.g. of Fe₂O₃ and having a thickness of 20 nm, a layer R, e.g. of Fe₃O₄ of thickness 3 nm, a layer NM, e.g. a 1.5 nm thick copper layer, a layer R′, e.g. of 1 nm thick Fe₃O₄, a layer Q′, e.g. of 2 nm thick NiFe and finally a protective layer P, e.g. of Ta.

It is also possible to form a symmetrical stack with a substrate, a buffer layer (Ta or NiFeCr alloy), a Ni₈₀Fe₂₀ layer, a Fe₃O₄ or NiFeO layer, a Cu layer, a Fe₃O₄ layer and a Fe₂O₃ layer.

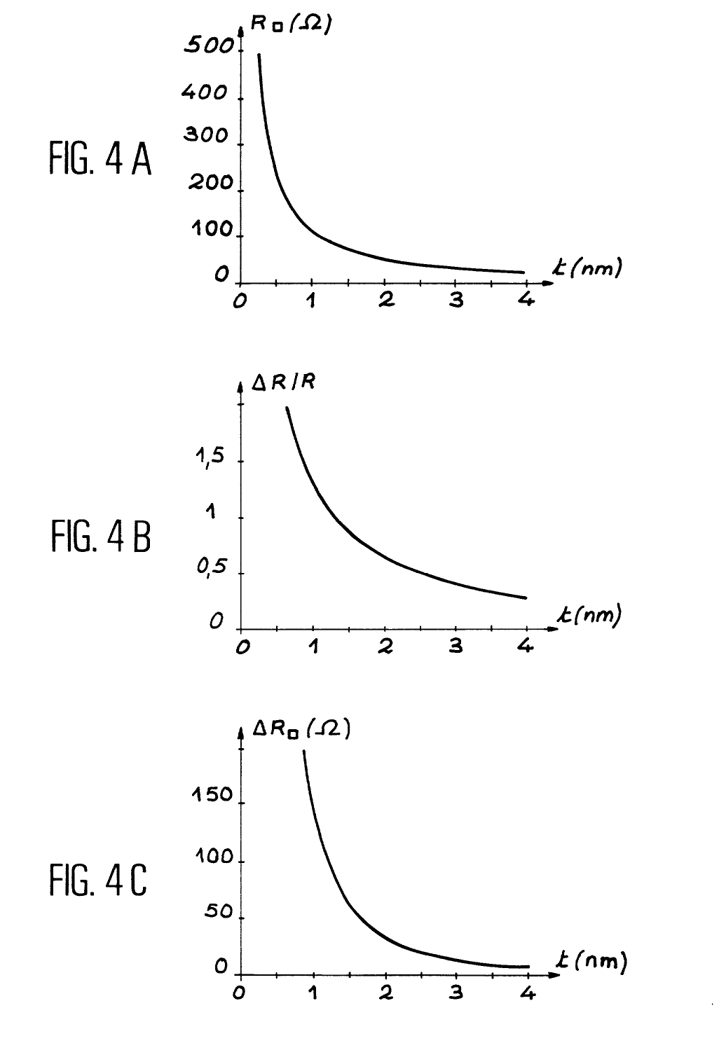

FIGS. 4A, 4B and 4C show the sheet resistance variations (4A), the relative magnetoresistance ΔR/R (4B) and the absolute sheet magnetoresistance (4C) as a function of the thickness t of the nonmagnetic layer in nanometres.

These drawings correspond to 10 nm Fe₃O₄ layers R and R′ and a copper layer NM. It has been assumed that the specular reflection is perfect for the electrons, whose spin is parallel to the magnetization and completely diffuse for the electrons, whose spin is antiparallel (which can be symbolically represented R↑=1 and R↓=0, where R designates the specular reflection coefficient and the arrows the parallelism (↑) or antiparallelism (↓) of the spins of the electrons relative to the local magnetization of the material.

Thus, these drawings show the transport properties which can be obtained in the ideal case, where the refelection is perfectly specular for one category of electrons and totally diffuse for the other category of electrons. The relative magnetoresistance amplitude can extremely high in this case, several dozen per cent compared with 10 to 15% in the best, presently available spin valve. The absolute magnetoresistance amplitude is particularly high in view of the high resistance of these layers. It can reach several dozen ohm², whereas it is approximately 2 to 3 ohms in the best existing spin valves.

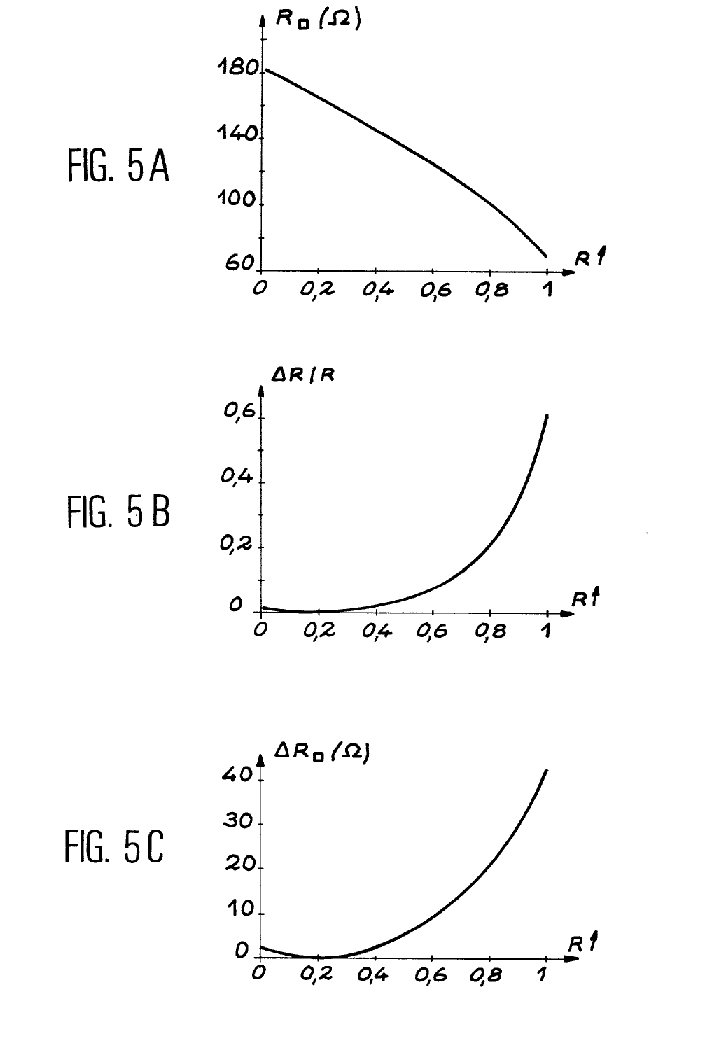

FIGS. 5A, 5B and 5C show the variations of these same magnitudes for a thickness of the nonmagnetic layer of 1.5 nm as a function of R↑ knowing that R↓ is equal to 0.2. For the realistic values which can be expected with materials such as Fe₃O₄, R↑=0.8, R↓=0.2, magnetoresistance amplitudes ΔR/R of approximately 20% can be obtained with an absolute magnetoresistance of 20 Ω.

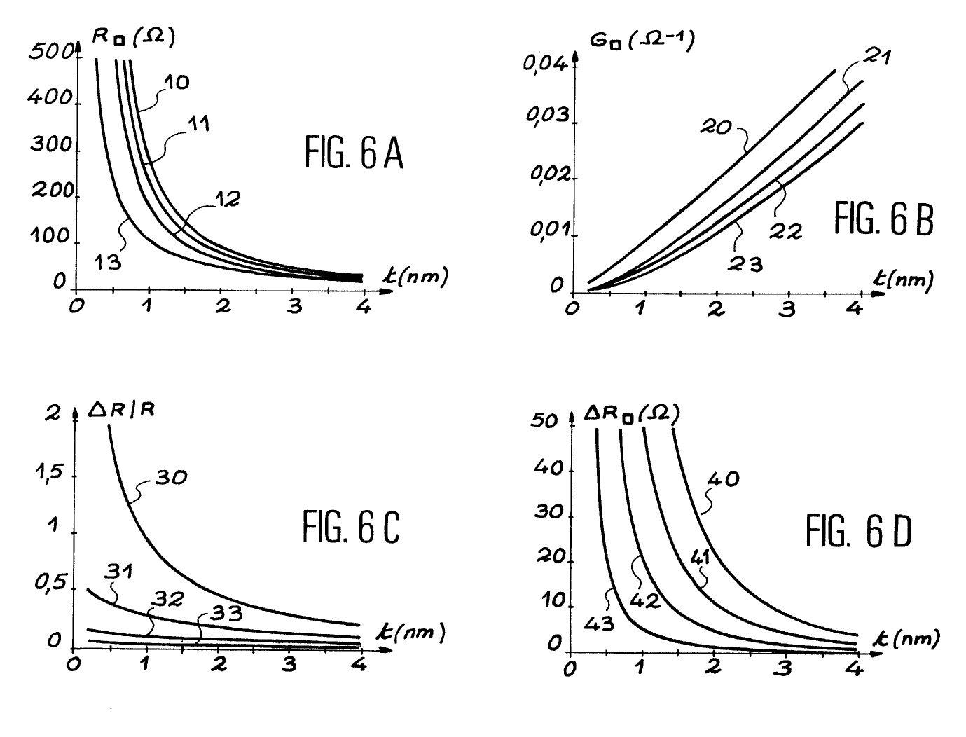

FIGS. 6A, 6B, 6C and 6D show the influence of the thickness t of the nonmagnetic, separating layer NM on the transport properties for different reflection contrasts. For these four drawings R↓ is 0.2. The correspondence between the different curves and the reflection coefficient R↑ is as follows:

| FIG. | Curve | R↑ |
|---|---|---|
| 6A | 10 | 0.4 |
| | 11 | 0.6 |
| | 12 | 0.8 |
| | 13 | 1 |
| 6B | 20 | 1 |
| | 21 | 0.8 |
| | 22 | 0.6 |
| | 23 | 0.4 |
| 6C | 30 | 1 |
| | 31 | 0.8 |
| | 32 | 0.6 |
| | 33 | 0.4 |
| 6D | 40 | 1 |
| | 41 | 0.8 |
| | 42 | 0.6 |
| | 43 | 0.4 |

2. Second variant: structure of type F/NM/R:

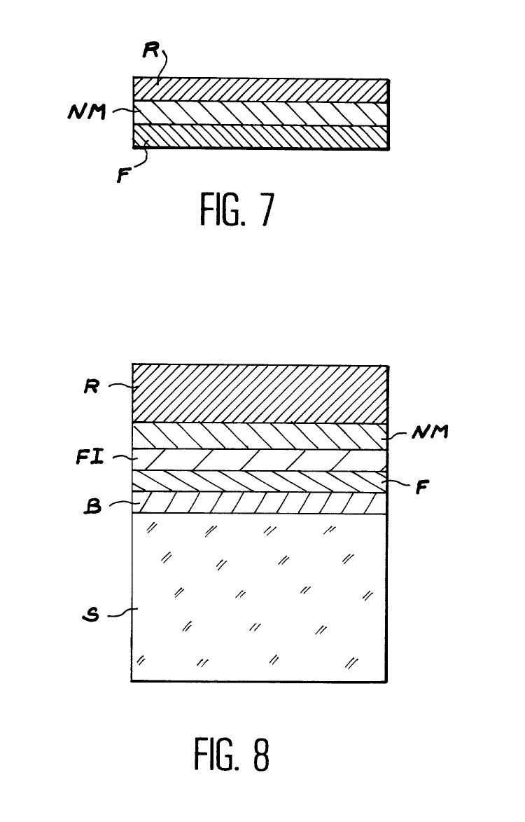

FIG. 7 diagrammatically illustrates a stack in accordance with the second variant of the invention. The stack shown comprises a layer F, where there are spin-dependent, diffusion effects, a nonmagnetic layer NM and a layer R having spin-dependent, electronic reflection effects relative to the magnetization direction in the layer R. As for existing spin valves, the layer F can be associated with a layer of another ferromagnetic material inserted between the layers F and NM in order to increase the dependent diffusion of the spin at the interface F/NM. This layer is normally of Co₉₀Fe₁₀. Moreover, the layer F can be deposited on a buffer layer for promoting the growth of the structure (e.g. of Ta or NiFeCr alloy). Part of the layer F can also be replaced by a nonmagnetic, conductive layer, e.g. of Cu or Ru. This is the spin filter-spin valve configuration known in the context of existing spin valves. The structure is then in the form buffer layer (NiFeCr, typically 5 nm)/nonmagnetic, conductive layer (typically Cu, 2 nm)/soft ferromagnetic layer typically Co₉₀Fe₁₀, 2 nm)/nonmagnetic, separating layer (typically Cu, 2 nm)/spin-selective, reflective layer (e.g. Fe₃O₄, 20 nm)/non-conductive, pinning layer (e.g. Fe₂O₃).

It is also possible to introduce at the interface of the layer F opposite to the layer NM, a thin oxide layer or a Ru layer for reflecting the electrons in the direction of the separating layer NM. This is actually done at present in spin valves by introducing oxide layers with a subnanometric thickness in order to increase the specular reflection of the electrons.

The spin filter-spin valve configuration or the introduction of a specular reflection into the soft ferromagnetic layer makes it possible to reduce the magnetic layer thickness, which increases the sensitivity of the magnetic field sensor. Thus, for a given magnetic flux quantity penetrating the sensor, the magnetization of the soft layer will change more under the effect of the field applied as the thickness of said layer decreases.

This second variant makes it possible to establish whether a material R has spin-dependent reflection effects at the interface R/NM. It is in fact sufficient to implement a structure in the form substrate (e.g. Si)/Ta, 5 nm/Ni₈₀Fe₂₀, 4 nm/Co₉₀Fe₁₀, 1 nm/Cu 2.5 nm/R 20 nm and then measure the resistance of said structure in a field varying from −100 to +100 Oe, in which it is certain that the magnetization of the NiFe/CoFe layer has changed. If a magnetoresistance effect linked with the passage from parallelism to antiparallelism of the magnetizations of F and R, then the material R has a spin-dependent reflection which can be quantified with the aid of a semiclassical theory. However, if no resistance change has been observed, then the material R can have specular reflection, but the latter is not dependent on the electron spin.

FIG. 8 shows a structure of this type with a substrate S, a buffer layer B, a layer F, an interfacial, ferromagnetic layer FI, a layer NM and a layer R.

The material F is a soft material, whose magnetization can easily follow the variations of the field applied when the magnetization R is pinned either because R is a magnetically hard material, or because the magnetization of R is coupled with a preferably insulating, anti-ferromagnetic material such as Fe₂O₃.

The advantage of these structures of the second variant compared with those of the first variant is that the materials used for F can be the same as in conventional spin valves (permalloy, alloys CoFe, CoFeB, etc.). Thus, the expert will easily know how to implement this soft magnetic material layer. However, in the structures of the first variant, it is one of the layers R or R′ which must be magnetically soft. This is less easy to implement, because materials liable to have spin-dependent, specular reflection effects are a priori hard materials. As discussed hereinbefore, this is the reason why it is necessary to combine said material R with a soft material layer in order to increase its magnetic susceptibility. However, this has the effect of deriving part of the current into said soft layer, which reduces the magnetoresistance performance characteristics.

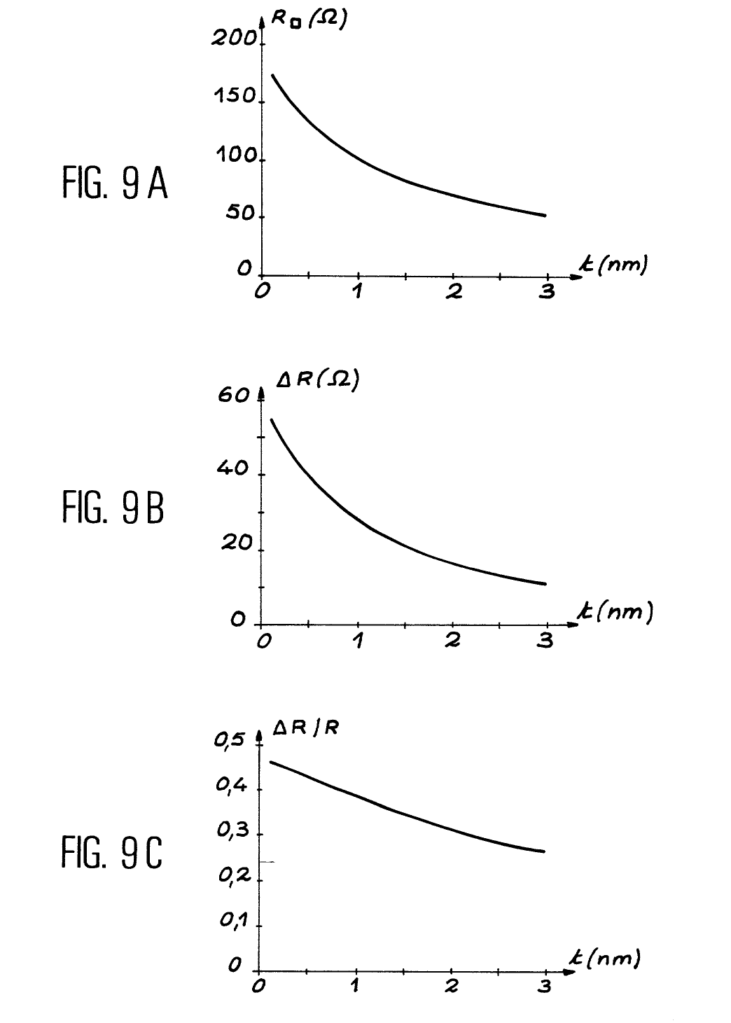

In the structures of the second variant, the change in the relative orientation of the magnetizations of F and R produces an electrical resistance change in the structure. This is illustrated in FIGS. 9A, 9B and 9C on the one hand and 10A, 10B, 10C on the other. The materials and the parameters relative to these results are as follows:

Structure:

| | |
|---|---|
| Buffer layer | NiFeCr |
| Layer F | Ni₈₀Fe₂₀ |
| Intermediate layer F | Co₉₀Fe₁₀ |
| Layer NM | Cu |
| Layer R | magnetic oxide |

Volume parameters:

| | Average free | Average free |
|---|---|---|
| Material | path (nm) spin ↑ | path (nm) spin ↓ |
| NiFeCr | 0.4 | 0.4 |
| Ni₈₀Fe₂₀ | 7 | 0.7 |
| Co₉₀Fe₁₀ | 9 | 0.9 |
| Cu | 12 | 12 |

Parameters at the interfaces:

| Interface | Transmission ↑ | Transmission ↓ | Reflection ↑ | Reflection ↓ |
|---|---|---|---|---|
| NiFeCr/ | 0 | 0 | 0.3 | 0.3 |
| NiFe | | | | |
| NiFe/ | 1 | 1 | 0 | 0 |
| CoFe | | | | |
| CoFe/Cu | 1 | 0.5 | 0 | 0 |
| Cu/R | 0 | 0 | 0.8 | 0 |

There is R↑=0.8 and R↓=0 at the NM/R interface.

FIGS. 9A, 9B and 9C show the variations of the resistance R, the absolute magnetoresistance ΔR and the relative magnetoresistance ΔR/R as a function of the thickness of the layer F in nm.

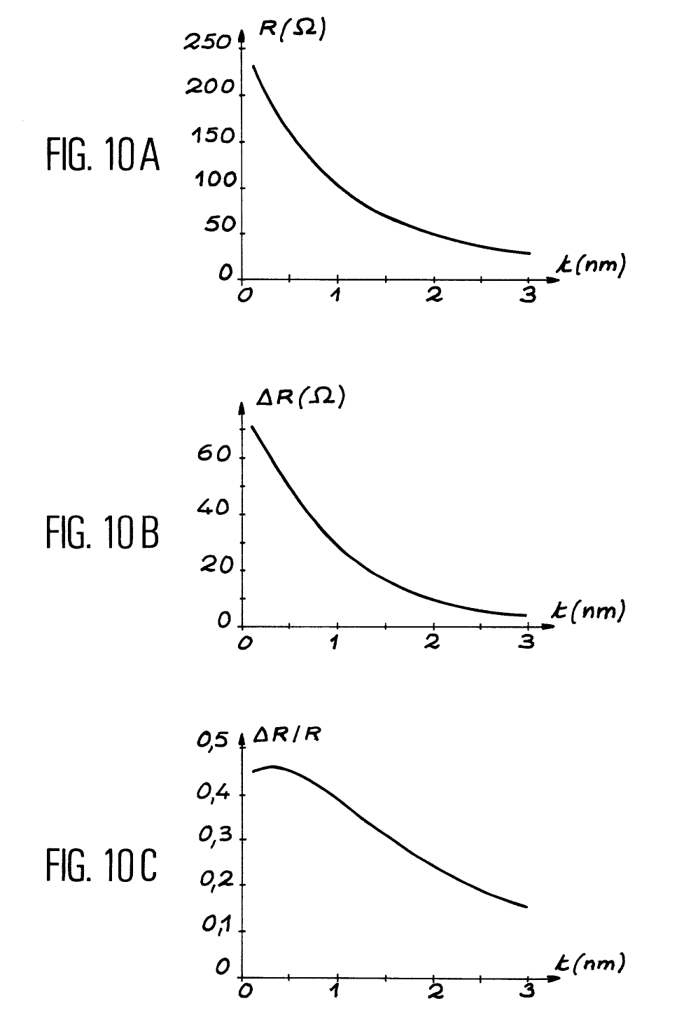

FIGS. 10A, 10B and 10C show the variations of said same magnitudes as a function of the thickness of the nonmagnetic, separating layer NM.

As for the structures of the first variant, very significant magnetoresistance amplitudes can be obtained. The thickness of the layer NM must be as small as possible, whilst maintaining the magnetic decoupling between the layers F and R (typically between 1 and 3 nm). Layer F must also be relatively thin (typically less than 5 nm).

3. Third variant: structure of type R/NM/F/NM/R′:

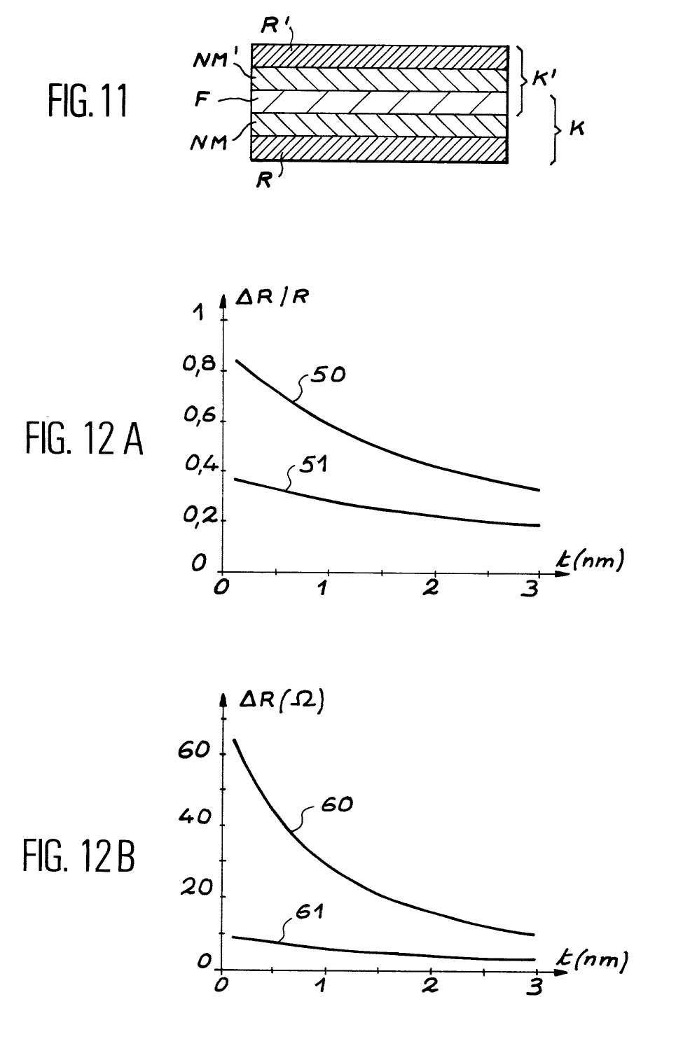

This third variant is illustrated in FIG. 11. A first stack K comprises layers R/NM/F, whilst a second stack K′ comprises layers F/NM′/R′. Therefore the layer F is common to both stacks.

These structures have a certain analogy with the known, dual spin valves. The soft magnetic layer, which responds to the variations of the field applied, is inserted in the median plane of the structure. This layer is separated from the two magnetic layers R and R′ having spin-dependent reflection effects, by two nonmagnetic layers NM, which are typically of 2 nm thick copper. The magnetizations of the layers R and R′ are pinned as in the previously described structures.

The properties of these structures are shown in FIGS. 12A and 12B for the following parameters:

Volume parameters

| | Average free | Average free |
|---|---|---|
| Material | path (nm) spin ↑ | path (nm) spin ↓ |
| NM (Cu) | 12 | 12 |
| Co₉₀Fe₁₀ | 9 | 0.9 |

Parameters at the interfaces:

| Interface | Transmission ↑ | Transmission ↓ | Reflection ↑ | Reflection ↓ |
|---|---|---|---|---|
| R/NM | 0 | 0 | 0.8 | 0 |
| NM/F | 1 | 0.5 | 0 | 0 |
| F/NM | 1 | 0.5 | 0 | 0 |
| NM/R | 0 | 0 | 0.8 | 0 |

FIG. 12A shows the variations of the relative magnetoresistance ΔR/R as a function of the thickness of the layer F with the thickness of the layer NM respectively equal to 1 nm (curve 50) and 2 nm (curve 51).

FIG. 12B shows the variations of the absolute magnetoresistance as a function of the thickness of layer F for a thickness of layer NM respectively equal to 1 nm (curve 60) and 2 nm (curve 61).

1. Spin valve device comprising at least one stack of layers comprising an electrically conductive, nonmagnetic layer (NM) placed between a first (R) and a second (R′, F) magnetic layers, the first (R) and second (R′, F) magnetic layers having a magnetization with a certain direction, said device being characterized in that at least one of said first and second magnetic layers (R, R′, F) has, at the interface with the nonmagnetic layer (NM), a specular reflection for the conduction electrons dependent on the orientation of the spin of the electrons relative to the magnetization direction in the magnetic layer or layers.

2. Device according to claim 1, wherein the magnetic layer or layers (R, R′) having a specular reflection are made from a material taken from within the group including ferrimagnetic oxides based on iron and/or nickel and/or cobalt and/or chrome or ferromagnetic nitrides based on iron and/or nickel and/or cobalt.

3. Device according to claim 1, wherein the electrically conductive, nonmagnetic layer (NM) is of a metal taken from within the group including copper, silver and gold.

4. Device according to claim 3, wherein the electrically conductive, nonmagnetic layer (NM) has a thickness less than approximately 10 nm.

5. Device according to claim 1, also comprising an anti-ferromagnetic layer adjacent to at least one of said first and second magnetic layers (R, R′).

6. Device according to claim 1, wherein the stack is deposited on a substrate (S).

7. Device according to claim 1, wherein the stack is covered by a protective layer (P).

8. Device according to claim 1, wherein the first (R) and second (R′) magnetic layers in each case have said electron specular reflection.

9. Device according to claim 1, wherein the first magnetic layer (R) has an electron specular reflection, the second magnetic layer (F) not having said specular reflection, but having a diffusion of the electrons dependent on the orientation of the spin of the electrons relative to the magnetization direction in said second layer (F).

10. Device according to claim 9, wherein the second magnetic layer (F) having a diffusion of the electrons is a material taken from within the group including transition metals, alloys based on nickel and/or iron and/or cobalt.

11. Device according to claim 10, also comprising a ferromagnetic layer adjacent to the second magnetic layer (F).

12. Device according to claim 1, wherein a first stack of layers (K) comprises a first electrically conductive, nonmagnetic layer (NM) placed between a first magnetic layer (R) and a second magnetic layer (F) and a second stack (K′) of layers comprising a first electrically conductive, nonmagnetic layer (NM′) placed between a first magnetic layer (F) and a second magnetic layer (R′), the second magnetic layer of the first stack (K) coinciding with the first magnetic layer of the second stack (K′), said layer (F) having a diffusion of the electrons dependent on the orientation of the spin of the electrons, the first magnetic layer (R) of the first stack (K) and the second magnetic layer (R′) of the second stack (K′) having in each case a specular reflection of the electrons dependent on the orientation of said electrons.
